(19) United States
(12) Patent Application Publication
(10) Pub. No.: US 2014/0200758 A1
(43) Pub. Date: Jul. 17, 2014

(54) HYBRID VEHICLE

(71) Applicant: Masayuki BABA, Toyota-shi (JP)

(72) Inventor: Masayuki BABA, Toyota-shi (JP)

(73) Assignee: TOYOTA JIDOSHA KABUSHIKI KAISHA, Toyota-shi (JP)

(21) Appl. No.: 14/156,807

(22) Filed: Jan. 16, 2014

(30) Foreign Application Priority Data
Jan. 17, 2013 (JP) 2013-005994

(51) Int. Cl. B60W 20/00; B60W 10/08; B60W 10/26; B60W 10/06

(52) U.S. Cl. CPC B60W 20/108; B60W 10/06; B60W 10/08; B60W 10/26; Y10S 903/93
USPC 701/22; 180/65.265; 903/930

(57) ABSTRACT

A control device is configured to, during acceleration, set a first operation point on a basis of an engine output power and a high torque constraint, set a second operation point on a basis of the engine output power and a high efficiency constraint, set a target operation point so that a target rotation speed of the engine is varied from a first operation rotation speed toward a second operation rotation speed and the engine output power is output from the engine, set a third operation point on a basis of a travel required power and the high efficiency constraint after that, and vary the target rotation speed from the second operation rotation speed toward a third operation rotation speed and set the target operation point so that the engine is operated at the target operation point to operate the engine in accordance with the high efficiency constraint.

### INCORPORATION BY REFERENCE

The disclosure of Japanese Patent Application No. 2013-005994 filed on Jan. 17, 2013 including the specification, drawings and abstract is incorporated herein by reference in its entirety.

### BACKGROUND OF THE INVENTION

1. Field of the Invention

The invention relates to a hybrid vehicle. Specifically, the invention relates to a hybrid vehicle that includes an engine, a first motor, a planetary gear unit, a second motor, a battery and a control device.

2. Description of Related Art

There has been conventionally suggested an example of a hybrid vehicle that includes an engine, a first motor, a planetary gear unit, a second motor and a battery. In the planetary gear unit, a ring gear, a carrier and a sun gear are respectively connected to a drive shaft coupled to an axle, an output shaft of the engine and a rotary shaft of the first motor. In addition, a rotary shaft of the second motor is connected to the drive shaft, and the battery exchanges electric power with the first motor and the second motor. In the hybrid vehicle, when the state of the battery falls outside a state within an allowable input/output range, an operating point indicated by a target rotation speed and target torque of the engine is set by using an operation line along which a variation in rotation speed relative to a variation in power becomes smaller than usual because of the setting such that the rotation speed of the engine is higher on a low-power side with respect to an ordinary power line. Then, the engine, the first motor and the second motor are controlled such that the hybrid vehicle travels at a required power while the engine is operated at the set operating point (for example, see Japanese Patent Application Publication No. 2006-77600 (JP 2006-77600 A)). The thus configured vehicle is able to smoothly output a required driving force to the drive shaft by increasing the response of the engine for a required power through the above control.

Generally, as in the case of the above-described hybrid vehicle, as a vehicle that changes the operation line in response to a required power of the engine, there is a vehicle that, when there is a large driver's acceleration request, changes the operation line for operating the engine from an ordinary operation line along which the engine is efficiently operated to an operation line along which the response of the required power is increased. In the thus configured hybrid vehicle, although the response of the engine to a required power increases, the engine cannot be operated such that the fuel economy of the engine is good, so the overall energy efficiency of the vehicle decreases. In addition, if the engine is operated in accordance with the ordinary operation line without changing the operation line as described above, there occurs a deviation between an acceleration request and a variation in the rotation speed of the engine, expected by the driver, so drivability may deteriorate.

### SUMMARY OF THE INVENTION

The invention provides a hybrid vehicle that suppresses a decrease in energy efficiency while suppressing a decrease in drivability when an acceleration request has been issued.

A hybrid vehicle according to an aspect of the invention includes an engine, a first motor, a planetary gear unit, a second motor, a battery and a control device. The planetary gear unit includes a ring gear connected to a drive shaft coupled to a wheel, a carrier connected to an output shaft of the engine, and a sun gear connected to a rotary shaft of the first motor. A rotary shaft of the second motor is connected to the drive shaft. The battery is configured to exchange electric power with the first motor and the second motor. The control device is configured to control the engine, the first motor and the second motor so that the hybrid vehicle travels at a travel required power obtained by adding a charge required amount of the battery to a power required for the hybrid vehicle to travel while the engine is operated at a set target operation point. Furthermore, the control device is configured to, when acceleration is required, set a first operation point indicated by a first operation rotation speed and a first operation torque on a basis of an engine output power, obtained by subtracting an output limit of the battery from the travel required power, and a high torque constraint that outputting a high torque from the engine is given a higher priority than efficiently operating the engine; set a second operation point indicated by a second operation rotation speed and a second operation torque on a basis of the engine output power and a predetermined constraint that the engine is allowed to be efficiently operated; and set the target operation point so that a target rotation speed of the engine is varied at a predetermined temporal variation from the first operation rotation speed toward the second operation rotation speed and the engine output power is output from the engine. Then, the control device is configured to, when the rotation speed of the engine has reached the second operation rotation speed after the target rotation speed of the engine has been varied at the predetermined temporal variation from the first operation rotation speed toward the second operation rotation speed, set a third operation point indicated by a third operation rotation speed and a third operation torque on a basis of the travel required power and the predetermined constraint; and vary the target rotation speed at the predetermined temporal variation from the second operation rotation speed toward the third operation rotation speed and set the target operation point so that the engine is operated at the target operation point so as to operate the engine in accordance with the predetermined constraint.

In the hybrid vehicle according to the aspect of the invention, the engine, the first motor and the second motor are controlled so that the hybrid vehicle travels at the travel required power while the engine is operated at the target operation point set as described above. The target rotation speed is set so as to vary at the predetermined temporal variation from the first operation rotation speed toward the second operation rotation speed, so it is possible to suppress a decrease in drivability when acceleration is required. After that, when the rotation speed of the engine has reached the second operation rotation speed, the third operation point indicated by the third operation rotation speed and the third operation torque is set on the basis of the travel required power and the predetermined constraint. The target operation point is set so that the target rotation speed is varied at the predetermined temporal variation from the second operation rotation speed toward the third operation rotation speed and the engine is operated in accordance with the predetermined constraint. Then, the engine, the first motor and the second motor are controlled so that the hybrid vehicle travels at the travel required power while the engine is operated at the set target operation point. The rotation speed of the engine is varied at the predetermined temporal variation from the second operation rotation speed toward the third operation rotation speed, so it is possible to suppress a decrease in drivability, and it is possible to operate the engine in accordance with the predetermined constraint. Thus, it is possible to improve energy efficiency. Thus, it is possible to suppress a decrease in drivability and improve energy efficiency at the time when acceleration is required.

In the hybrid vehicle according to the aspect of the invention, the predetermined temporal variation may be set so as to increase as an amount of electric power stored in the battery increases. The predetermined temporal variation may be set so as to increase as a road surface gradient increases. With this configuration, it is possible to more quickly increase the rotation speed of the engine.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a configuration view that schematically shows the configuration of a hybrid vehicle 20 according to an embodiment of the invention;

FIG. 2 is a flowchart that shows an example of an acceleration drive control routine that is executed by a hybrid electronic control unit 70 according to the embodiment;

FIG. 3 is a graph that illustrates an example of the correlation between a battery temperature Tb and input/output limits Win, Wout of a battery 50;

FIG. 4 is a graph that illustrates an example of the correlation between a state of charge (SOC) of the battery 50 and correction coefficients for the input/output limits Win, Wout;

FIG. 5 is a graph that illustrates an example of a required torque setting map;

FIG. 6 is a graph that illustrates an example of an operation line and a high torque line during ordinary operation of an engine 22 and an example of settings of an intermediate rotation speed Nmidl, intermediate torque Tmidl, control start rotation speed Nst, control start torque Tst, control end rotation speed Nstop and control end torque Tstop;

FIG. 7 is a graph that shows an example of a nomograph for mechanically illustrating rotating elements of a power distribution/integration mechanism 30;

FIG. 8 is a graph that shows an example of a temporal variation in a target rotation speed Ne* of the engine 22;

FIG. 9 is a configuration view that shows the schematic configuration of a hybrid vehicle 120 according to an alternative embodiment; and

FIG. 10 is a configuration view that shows the schematic configuration of a hybrid vehicle 220 according to an alternative embodiment.

### DETAILED DESCRIPTION OF EMBODIMENTS

Next, a mode for carrying out the invention will be described with reference to an embodiment.

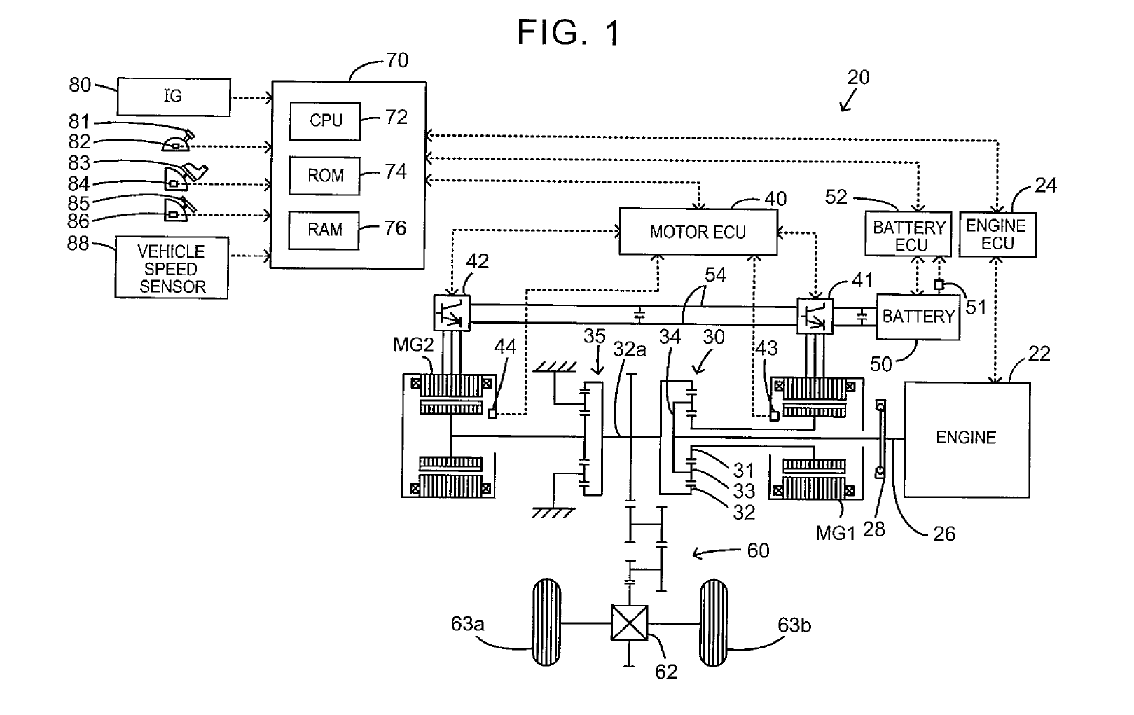

FIG. 1 is a configuration view that shows the schematic configuration of a hybrid vehicle 20 according to an embodiment of the invention. As shown in the drawing, the hybrid vehicle 20 according to the embodiment includes an engine 22, a triaxial power distribution/integration mechanism 30, a motor MG1, a speed reduction gear 35, a motor MG2 and a hybrid electronic control unit 70. The power distribution/integration mechanism 30 is connected to a crankshaft 26 via a damper 28. The crankshaft 26 serves as an output shaft of the engine 22. The motor MG1 is connected to the power distribution/integration mechanism 30, and is able to generate electric power. The speed reduction gear 35 is connected to a ring gear shaft 32a. The ring gear shaft 32a is connected to the power distribution/integration mechanism 30, and serves as a drive shaft. The motor MG2 is connected to the speed reduction gear 35. The hybrid electronic control unit 70 controls a system overall.

The engine 22 is an internal combustion engine that outputs driving force by using hydrocarbon-based fuel, such as gasoline and light oil. The engine 22 undergoes operation control, such as fuel injection control, ignition control and intake air amount control, from an engine electronic control unit (hereinafter, referred to as engine ECU) 24. The engine ECU 24 receives signals from various sensors that detect operating states of the engine 22. The engine ECU 24 communicates with the hybrid electronic control unit 70, and executes operation control over the engine 22 on the basis of a control signal from the hybrid electronic control unit 70. In addition, the engine ECU 24 outputs data about the operating states of the engine 22 to the hybrid electronic control unit 70 as needed.

The power distribution/integration mechanism 30 includes a sun gear 31, a ring gear 32, a plurality of pinion gears 33 and a carrier 34. The sun gear 31 is formed of an external gear. The ring gear 32 is formed of an internal gear and is arranged concentrically with the sun gear 31. The plurality of pinion gears 33 are in mesh with the sun gear 31 and are in mesh with the ring gear 32. The carrier 34 retains the plurality of pinion gears 33 such that the pinion gears 33 are rotatable and revolvable. The power distribution/integration mechanism 30 is configured as a planetary gear mechanism that carries out differential action by using the sun gear 31, the ring gear 32 and the carrier 34 as rotating elements. In the power distribution/integration mechanism 30, the crankshaft 26 of the engine 22 is connected to the carrier 34, the motor MG1 is connected to the sun gear 31, and the speed reduction gear 35 is connected to the ring gear 32 via the ring gear shaft 32a. When the motor MG1 functions as a generator, driving force of the engine 22, input from the carrier 34, is distributed between the sun gear 31 side and the ring gear 32 side in accordance with the gear ratio of them. When the motor MG1 functions as an electric motor, driving force of the engine 22, input from the carrier 34, and driving force of the motor MG1, input from the sun gear 31, are integrated and output to the ring gear 32 side. Driving force output to the ring gear 32 is finally output from the ring gear shaft 32a to drive wheels 63a, 63b of the vehicle via a gear mechanism 60 and a differential gear 62.

The motor MG1 and the motor MG2 each are configured as a known synchronous generator-motor that is able to be driven as a generator and is able to be driven as an electric motor. The motor MG1 and the motor MG2 exchange electric power with a battery 50 via corresponding inverters 41, 42. Power lines 54 that connect the inverters 41, 42 with the battery 50 are respectively configured as a positive electrode bus and a negative electrode bus that are shared between the inverters 41, 42, and are configured such that electric power that is generated by one of the motors MG1, MG2 is allowed to be consumed by the other one of the motors. Thus, the battery 50 is charged with electric power generated from any one of the motors MG1, MG2 or is discharged in accordance with electric power that is insufficient in any one of the motors MG1, MG2. If the input and output of electric power are balanced by the motors MG1, MG2, the battery 50 is not charged or discharged. The motors MG1, MG2 each undergo drive control over a motor electronic control unit (hereinafter, referred to as motor ECU) 40. Signals required to execute drive control over the motors MG1, MG2 are input to the motor ECU 40. The required signals are, for example, signals from rotation position detection sensors 43, 44 phase currents and the like. The detection sensors 43, 44 respectively detect rotation positions of rotors of the motors MG1, MG2. The phase currents are respectively applied to the motors MG1, MG2 and detected by current sensors (not shown). In addition, switching control signals are output from the motor ECU 40 to the inverters 41, 42. The motor ECU 40 communicates with the hybrid electronic control unit 70. The motor ECU 40 executes drive control over the motors MG1, MG2 in accordance with control signals from the hybrid electronic control unit 70, and outputs data about the operating states of the motors MG1, MG2 to the hybrid electronic control unit 70 as needed.

The battery 50 is managed by a battery electronic control unit (hereinafter, referred to as battery ECU) 52. Signals required to manage the battery 50 are input to the battery ECU 52. The required signals are, for example, a terminal voltage from a voltage sensor (not shown) provided between the terminals of the battery 50, a charge/discharge current from a current sensor (not shown), a battery temperature Tb from a temperature sensor 51 provided at the battery 50, and the like. The current sensor is provided in the power line 54 connected to the output terminal of the battery 50. The battery ECU 52 outputs data about the state of the battery 50 to the hybrid electronic control unit 70 as needed. In the battery ECU 52, a state of charge (SOC) is also computed on the basis of an accumulated value of charge/discharge current detected by the current sensor in order to manage the battery 50.

The hybrid electronic control unit (hereinafter, referred to as HVECU 70) 70 is configured as a microprocessor that mainly includes a CPU 72. In addition to the CPU 72, the HVECU 70 includes a ROM 74 that stores a processing program, a RAM 76 that temporarily stores data, input/output ports (not shown) and a communication port. An ignition signal, a shift position SP, an accelerator operation amount Acc, a brake pedal position BP, a vehicle speed V, and the like, are input to the HVECU 70 via the input port. The ignition signal is supplied from an ignition switch 80. The shift position SP is supplied from a shift position sensor 82 that detects the operating position of a shift lever 81. The accelerator operation amount Ace is supplied from an accelerator pedal position sensor 84 that detects the depression amount of an accelerator pedal 83. The brake pedal position BP is supplied from a brake pedal position sensor 86 that detects the depression amount of a brake pedal 85. The vehicle speed V is supplied from a vehicle speed sensor 88. As described above, the HVECU 70 is connected to the engine ECU 24, the motor ECU 40 and the battery ECU 52 via the communication port, and exchanges various control signals or data with the engine ECU 24, the motor ECU 40 and the battery ECU 52.

The thus configured hybrid vehicle 20 according to the embodiment computes a required torque that should be output to the ring gear shaft 32a as the drive shaft on the basis of the accelerator operation amount Acc, which corresponds to the driver's depression amount of the accelerator pedal 83, and the vehicle speed V. Then, the hybrid vehicle 20 executes operation control over the engine 22, the motor MG1 and the motor MG2 such that a required driving force corresponding to the required torque is output to the ring gear shaft 32a. The operation control over the engine 22, the motor MG1 and the motor MG2 includes a torque conversion operation mode, a charge/discharge operation mode, a motor operation mode, and the like. In the torque conversion operation mode, the engine 22 undergoes operation control such that a driving force corresponding to a required driving force is output from the engine 22. In addition, in the torque conversion operation mode, the motor MG1 and the motor MG2 undergo drive control such that the entire driving force that is output from the engine 22 is converted to torque by the power distribution/integration mechanism 30, the motor MG1 and the motor MG2 and output to the ring gear shaft 32a. In the charge/discharge operation mode, the engine 22 undergoes operation control such that a driving force corresponding to the sum of a required driving force and an electric power required to charge or discharge the battery 50 is output from the engine 22. In addition, in the charge/discharge operation mode, the motor MG1 and the motor MG2 undergo drive control such that the entire or part of driving force that is output from the engine 22 while the battery 50 is charged or discharged is converted to torque by the power distribution/integration mechanism 30, the motor MG1 and the motor MG2 and then the required driving force is output to the ring gear shaft 32a. In the motor operation mode, operation is controlled such that the operation of the engine 22 is stopped and a driving force corresponding to a required driving force of the motor MG2 is output to the ring gear shaft 32a.

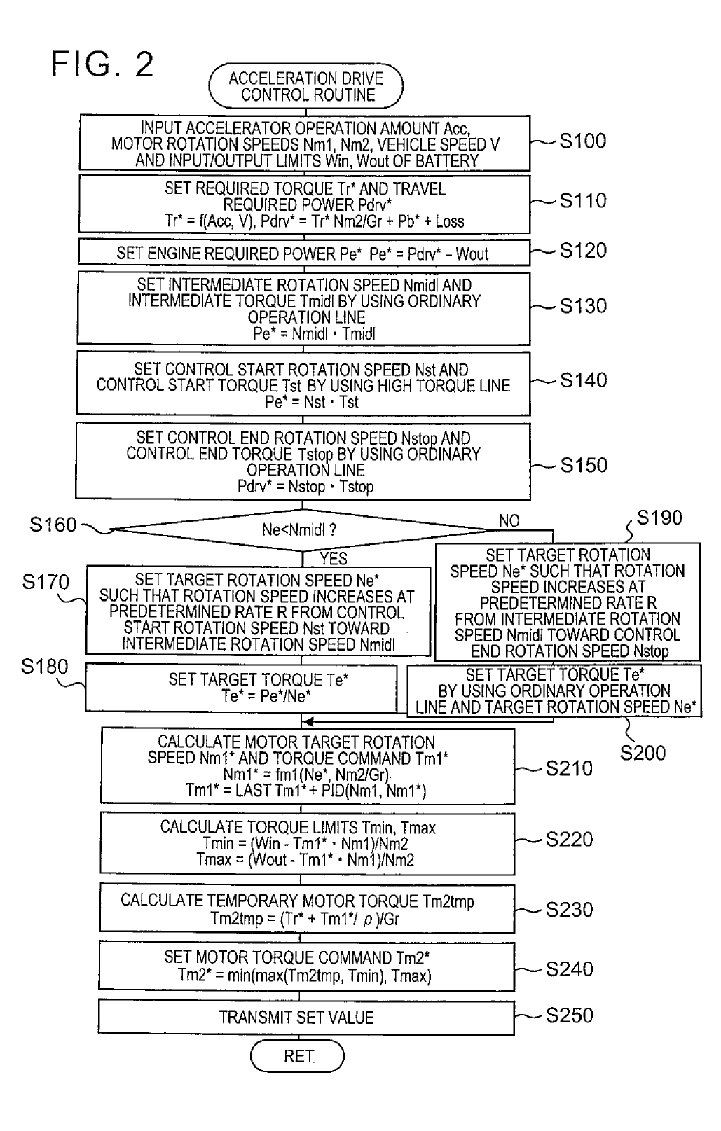

Next, the operation of the thus configured hybrid vehicle 20 according to the embodiment, particularly, the operation of the hybrid vehicle 20 at the time when acceleration is required, will be described. FIG. 2 is a flowchart that shows an example of an acceleration drive control routine that is executed by the HVECU 70. The routine is repeatedly executed at intervals of a predetermined period of time (for example, intervals of several milliseconds) when the accelerator pedal 83 is depressed and the accelerator operation amount Acc becomes a predetermined operation amount (for example, larger than or equal to 50%, or the like).

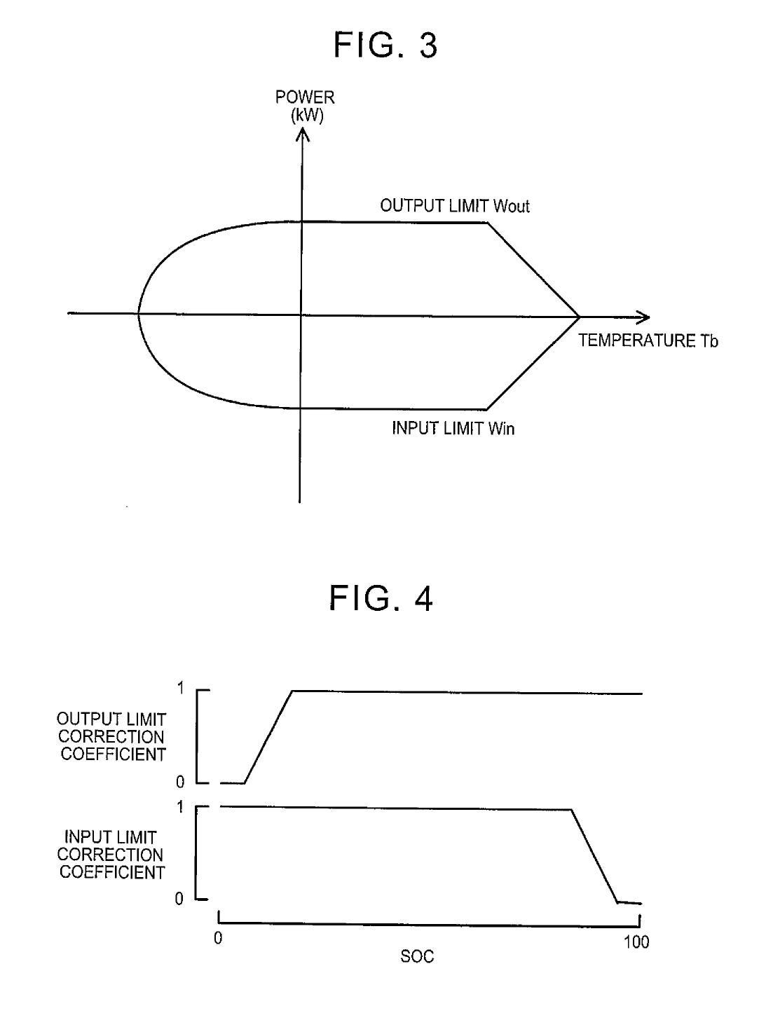

When the acceleration drive control routine is executed, the CPU 72 of the HVECU 70 initially executes the process of inputting data required for control, such as the accelerator operation amount Acc from the accelerator pedal position sensor 84, the vehicle speed V from the vehicle speed sensor 88, the rotation speed Nm1 of the motor MG1, the rotation speed Nm2 of the motor MG2 and input/output limits Win, Wout (electric power that is output from the battery 50 is indicated by a positive value) (step S100). The input/output limits Win, Wout are limit values of electric power that are respectively allowed to be input to or output from the battery 50. Here, the CPU 72 is configured to receive the rotation speed Nm1 of the motor MG1 and the rotation speed Nm2 of the motor MG2 in response to communication from the motor ECU 40. The rotation speed Nm1 of the motor MG1 and the rotation speed Nm2 of the motor MG2 are respectively detected by rotation position detection sensors 43, 44. In addition, the input/output limits Win, Wout of the battery 50 are set as follows. Basic values of the input/output limits Win, Wout are set on the basis of the battery temperature Tb of the battery 50, detected by the temperature sensor 51, an output limit correction coefficient and an input limit correction coefficient are set on the basis of the state of charge (SOC) that is the ratio of a stored electric power to a maximum value of electric power storable in the battery 50, and then the basic values of the set input/output limits Win, Wout are respectively multiplied by the corresponding correction coefficients to thereby obtain the input/output limits Win, Wout. The set input/output limits Win, Wout are input through communication from the battery ECU 52. FIG. 3 shows an example of the correlation between the battery temperature Tb and the input/output limits Win, Wout. FIG. 4 shows an example of the correlation between the state of charge (SOC) of the battery 50 and the correction coefficients for the input/output limits Win, Wout.

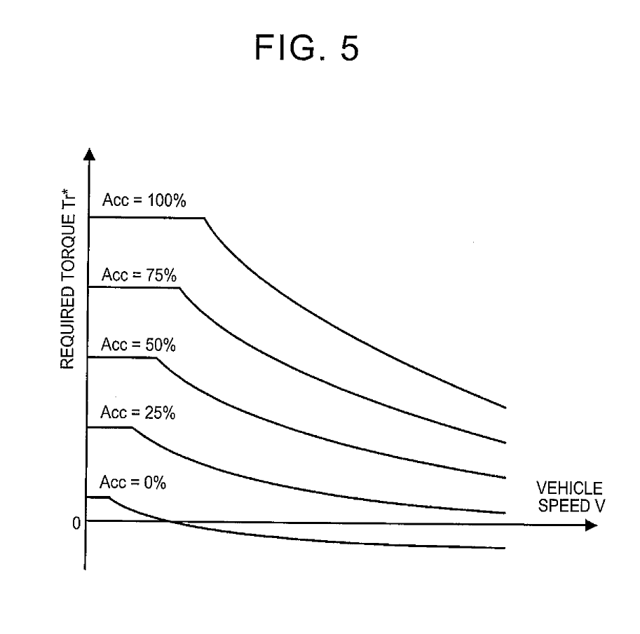

When the data are input in this way, a required torque Tr* and a travel required power Pdrv* are set on the basis of the input accelerator operation amount Acc and vehicle speed V (step S110). The required torque Tr* is torque that should be output to the ring gear shaft 32a, which serves as the drive shaft coupled to the drive wheels 63a, 63b, as a torque required of the vehicle. The travel required power Pdrv* is power required to cause the vehicle to travel. In the embodiment, the correlation among the accelerator operation amount Acc, the vehicle speed V and the required torque Tr* is predetermined and the predetermined correlation is stored in the ROM 74 as a required torque setting map. When the accelerator operation amount Acc and the vehicle speed V are given, the corresponding required torque Tr* is derived from the stored map and is set. FIG. 5 shows an example of the required torque setting map. The travel required power Pdrv* can be calculated as the sum of a power obtained by multiplying the set required torque Tr* by the rotation speed Nr of the ring gear shaft 32a, a charge/discharge required power Pb* required of the battery 50, and a power loss (Loss). The rotation speed Nr of the ring gear shaft 32a may be obtained by multiplying the vehicle speed V by a conversion coefficient k or may be obtained by dividing the rotation speed Nm2 of the motor MG2 by the gear ratio Gr of the speed reduction gear 35.

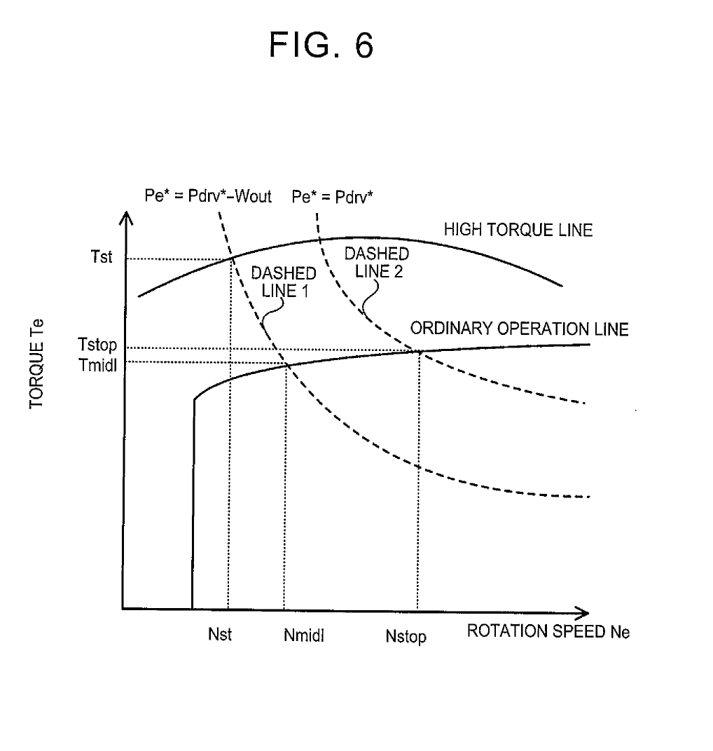

Subsequently, a power obtained by subtracting the output limit Wout from the travel required power Pdrv* is set as a required power Pe* that is required to be output from the engine 22 (step S120). An intermediate rotation speed Nmidl and an intermediate torque Tmidl are set on the basis of the set required power Pe* and an ordinary operation line along which the engine 22 is efficiently operated (step S130). A control start rotation speed Nst and a control start torque Tst are set on the basis of the set required power Pe* and a high torque line along which outputting a high torque from the engine 22 is given a higher priority than efficiently operating the engine 22 (step S140). A control end rotation speed Nstop and a control end torque Tstop are set on the basis of the set travel required power Pdrv* and the ordinary operation line along which the engine 22 is efficiently operated (step S150). Here, the ordinary operation line is predetermined as a line that is obtained by determining a most efficient operation point among operation points at which the engine 22 outputs the same power and continuously arranging the most efficient operation points while varying an output power. In addition, the high torque line is predetermined as a line that is obtained by determining a high torque operation point, at which the engine 22 is allowed to be operated at the highest torque, among the operation points at which the engine 22 outputs the same power and continuously arranging the high torque operation points while varying an output power. FIG. 6 shows an example of the ordinary operation line and high torque line of the engine 22, and an example of settings of the intermediate rotation speed Nmidl, the intermediate torque Tmidl, the control start rotation speed Nst, the control start torque Tst, the control end rotation speed Nstop and the control end torque Tstop. In the graph, the control start rotation speed Nst and the control start torque Tst can be obtained from the intersection of the high torque line and a curve (indicated by the dashed line 1) along which the required power Pe* obtained by subtracting the output limit Wout from the travel required power Pdrv* is constant. In addition, the intermediate rotation speed Nmidl and the intermediate torque Tmidl can be obtained from the intersection of the ordinary operation line and the curve (indicated by the dashed line 1) along which the required power Pe* obtained by subtracting the output limit Wout from the travel required power Pdrv* is constant. In addition, the control end rotation speed Nstop and the control end torque Tstop can be obtained from the intersection of the ordinary operation line and a curve (indicated by dashed line 2) along which the required power Pe* to which the travel required power Pdrv* is set is constant.

In this way, the intermediate rotation speed Nmidl, the intermediate torque Tmidl, the control start rotation speed Nst, the control start torque Tst, the control end rotation speed Nstop and the control end torque Tstop are set, and, subsequently, the rotation speed Ne of the engine 22 is compared with the intermediate rotation speed Nmidl (step S160). When the rotation speed Ne is lower than the intermediate rotation speed Nmidl, a target rotation speed Ne* of the engine 22 is set such that the rotation speed increases from the control start rotation speed Tst toward the intermediate rotation speed Nmidl at a predetermined rate R with a lapse of time (step S170). A target torque Te* of the engine 22 is set by dividing the required power Pe* by the target rotation speed Ne* (step S180). Here, the predetermined rate R is a predetermined value that is a temporal variation in the rotation speed of the engine 22 at which an occupant does not experience a feeling of strangeness when acceleration is required. Generally, when the driver requires acceleration, the driver expects that torque that is output from the engine 22 increases and the rotation speed increases. As in the case of the processes of step S170 and step S180, by setting the target rotation speed Ne* and target torque Te* of the engine 22, it is possible to cause the vehicle to travel in accordance with such a behavior that is expected by the driver.

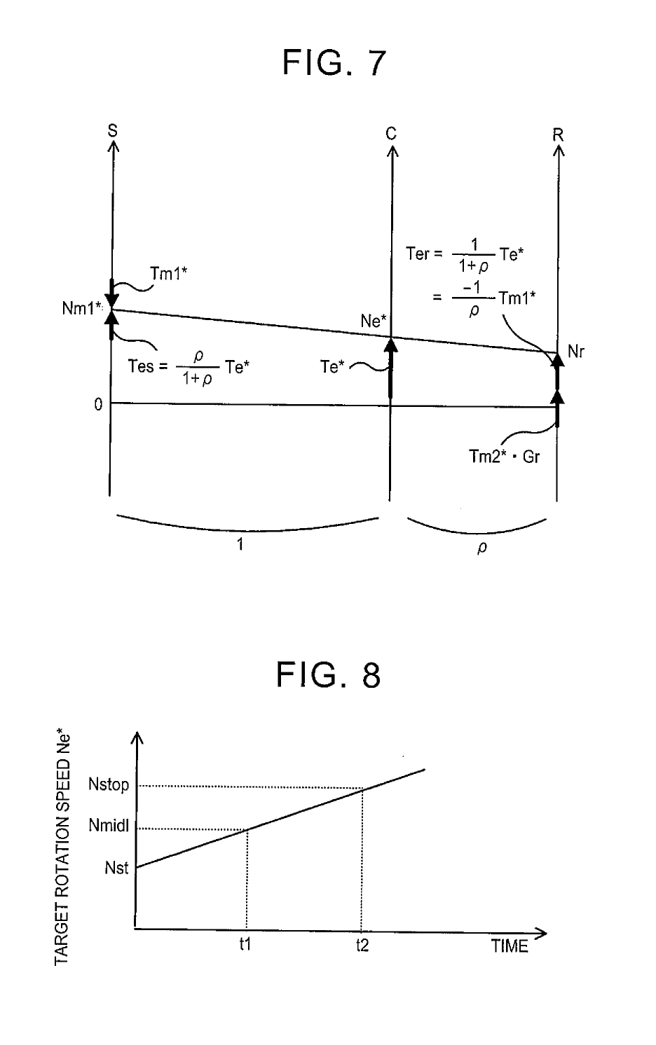

Subsequently, by using the set target rotation speed Ne*, the rotation speed Nr (Nm2/Gr) of the ring gear shaft 32a and a gear ratio ρ of the power distribution/integration mechanism 30, a target rotation speed Nm1* of the motor MG1 is calculated through the following mathematical expression (1). Then, a torque command Tm1* of the motor MG1 is calculated on the basis of the calculated target rotation speed Nm1* and a current rotation speed Nm1 through the mathematical expression (2) (step S210). Here, the mathematical expression (1) is a mechanical relational expression for the rotating elements of the power distribution/integration mechanism 30. FIG. 7 is a nomograph that shows the mechanical correlation in rotation speed and torque among the rotating elements of the power distribution/integration mechanism 30. In the graph, the left-side S axis represents the rotation speed of the sun gear 31, which is the rotation speed Nm1 of the motor MG1, the C axis represents the rotation speed of the carrier 34, which is the rotation speed Ne of the engine 22, and the R axis represents the rotation speed Nr of the ring gear 32, which is obtained by multiplying the rotation speed Nm2 of the motor MG2 by the gear ratio Gr of the speed reduction gear 35. The mathematical expression (1) may be easily derived when the nomograph is used. The two wide-line arrows on the R axis respectively indicate a torque that is obtained by transmitting the torque Te*, output from the engine 22, to the ring gear shaft 32a and a torque that is obtained by applying the torque Tm2*, output from the motor MG2, to the ring gear shaft 32a via the speed reduction gear 35 when the engine 22 is operated steadily at the operation point indicated by the target rotation speed Ne* and the target torque Te*. In addition, the mathematical expression (2) is a relational expression in feedback control for causing the motor MG1 to rotate at the target rotation speed Nm1*. In the mathematical expression (2), the second term “k1” on the right-hand side is a proportional gain, and the third term “k2” on the right-hand side is an integral gain.

Nm1*=Ne*·(1+ρ)/ρ−Nm2/(Gr·p) (1)

Tm1*=Last Tm1*+k1(Nm1*−Nm1)+k2∫(Nm1*−Nm1)dt (2)

The target rotation speed Nm1* and torque command Tm1* of the motor MG1 are calculated on the basis of the mathematical expression (2), and torque limits Tmin, Tmax that are lower and upper limits of torque, which are allowed to be output from the motor MG2, are calculated by dividing a deviation between each of the input/output limits Win, Wout of the battery 50 and an electric power consumed by (electric power generated by) the motor MG1 by the rotation speed Nm2 of the motor MG2 through the following mathematical expressions (3) and (4) (step S220). The electric power consumed by (electric power generated by) the motor MG1 is obtained by multiplying the calculated torque command Tm1* of the motor MG1 by the current rotation speed Nm1 of the motor MG1. In addition, by using the required torque Tr*, the torque command Tm1* and the gear ratio ρ of the power distribution/integration mechanism 30, a temporary motor torque Tm2tmp is calculated as a torque that should be output from the motor MG2 through the mathematical expression (5) (step S230). The temporary motor torque Tm2tmp is limited by the calculated torque limits Tmin, Tmax, and the torque command Tm2* of the motor MG2 is set (step S240). By setting the torque command Tm2* of the motor MG2 in this way, it is possible to set the required torque Tr* that is output to the ring gear shaft 32a serving as the drive shaft as a torque limited within the range of the input/output limits Win, Wout of the battery 50. The mathematical expression (5) may be easily derived from the above-described nomograph of FIG. 7.

Tmin=(Win−Tm1*·Nm1)/Nm2 (3)

Tmax=(Wout−Tm1*·Nm1)/Nm2 (4)

Tm2tmp=(Tr*+Tm1*/ρ)/Gr (5)

When the target rotation speed Ne* and target torque Te* of the engine 22, the torque command Tm1* of the motor MG1 and the torque command Tm2* of the motor MG2 are set in this way, the target rotation speed Ne* and target torque Te* of the engine 22 are transmitted to the engine ECU 24, and the torque command Tm1* of the motor MG1 and the torque command Tm2* of the motor MG2 are transmitted to the motor ECU 40 (step S250), after which the routine ends. The engine ECU 24 that has received the target rotation speed Ne* and the target torque Te* executes control, such as fuel injection control and ignition control, over the engine 22 such that the engine 22 is operated at the operation point indicated by the target rotation speed Ne* and the target torque Te*. In addition, the motor ECU 40 that has received the torque commands Tm1*, Tm2* executes switching control over the switching elements of the inverters 41, 42 such that the motor MG1 is driven at the torque command Tm1* and the motor MG2 is driven at the torque command Tm2*. Through such control, it is possible to cause the vehicle to travel by using power based on the travel required power Pdrv* while increasing the rotation speed of the engine 22 from the control start rotation speed Nst to the intermediate rotation speed Nmidl at the predetermined rate R. Thus, it is possible to cause the vehicle to travel at a behavior expected by the driver at the time of acceleration, and to suppress a decrease in drivability. At this time, the engine 22 is operated so as to output the required power Pe* obtained by subtracting the output limit Wout from the travel required power Pdrv*. Thus, the vehicle travels while discharging electric power of an amount corresponding to the output limit Wout from the battery 50, so the state of charge (SOC) of the battery 50 gradually decreases.

When the rotation speed Ne of the engine 22 increases in this way to the intermediate rotation speed Nmidl or higher, the target rotation speed Ne* of the engine 22 is set such that the rotation speed increases at the predetermined rate R from the intermediate rotation speed Nmidl toward the control end rotation speed Nstop with a lapse of time (step S190). In addition, the target torque Te* of the engine 22 is set to a value at the intersection of the ordinary operation line illustrated in FIG. 6 with a line along which the target rotation speed Ne* is constant (step S200). The above-described processes of step S210 to step S250 are executed, after which the routine ends. Through the above processes, it is possible to increase the rotation speed of the engine 22 toward the control end rotation speed Nstop while shifting the operation point indicated by the target rotation speed Ne* and target torque Te* of the engine 22 along the ordinary operation line. Thus, it is possible to increase the rotation speed of the engine 22 while efficiently operating the engine 22, so it is possible to improve energy efficiency and suppress a decrease in drivability. At this time, power that is output from the engine 22 increases to become the travel required power Pdrv*, so it is possible to recover the state of charge (SOC) of the battery 50, which has decreased in the processes of step S100 to step S180, and step S210 to step S250. Thus, it is possible to properly manage the battery 50. FIG. 8 shows an example of a temporal variation in the target rotation speed Ne* of the engine 22. Through the above control, it is possible to increase the rotation speed Ne of the engine 22 at the predetermined rate R, so it is possible to suppress a decrease in drivability, and to cause the vehicle to travel at the travel required power Pdrv*.

In the above-described hybrid vehicle 20 according to the embodiment, when acceleration is required, the engine 22 and the motors MG1, MG2 are controlled such that the vehicle is caused to travel at the power based on the travel required power Pdrv* while increasing the rotation speed of the engine 22 at the predetermined rate R from the control start rotation speed Nst to the intermediate rotation speed Nmidl. After that, the engine 22 and the motors MG1, MG2 are controlled such that the vehicle is caused to travel at the power based on the travel required power Pdrv* while operating the engine 22 such that the rotation speed of the engine 22 increases at the predetermined rate R from the intermediate rotation speed Nmidl to the control end rotation speed Nstop and the operation point of the engine 22 shifts along the ordinary operation line. Thus, when an acceleration request is issued, it is possible to cause the vehicle to travel at a behavior that is expected by the driver, so it is possible to suppress a decrease in drivability and to suppress a decrease in energy efficiency.

In the hybrid vehicle 20 according to the embodiment, the predetermined rate R that is used in the processes of step S170 and step S190 is a value predetermined as a temporal variation in the rotation speed of the engine 22, at which an occupant does not experience a feeling of strangeness when acceleration is required. Instead, the predetermined rate R may be set so as to increase as the state of charge (SOC) of the battery 50 increases. Alternatively, the predetermined rate R may be set so as to increase as a road surface gradient increases. With this configuration, it is possible to more quickly increase the rotation speed of the engine 22.

In the hybrid vehicle 20 according to the embodiment, in order to determine the state of the battery 50, the input/output limits Win, Wout of the battery 50, set on the basis of the battery temperature Tb of the battery 50 and the state of charge (SOC) of the battery 50, are used. Instead, the battery temperature Tb of the battery 50 may be used or the state of charge (SOC) of the battery 50 may be used.

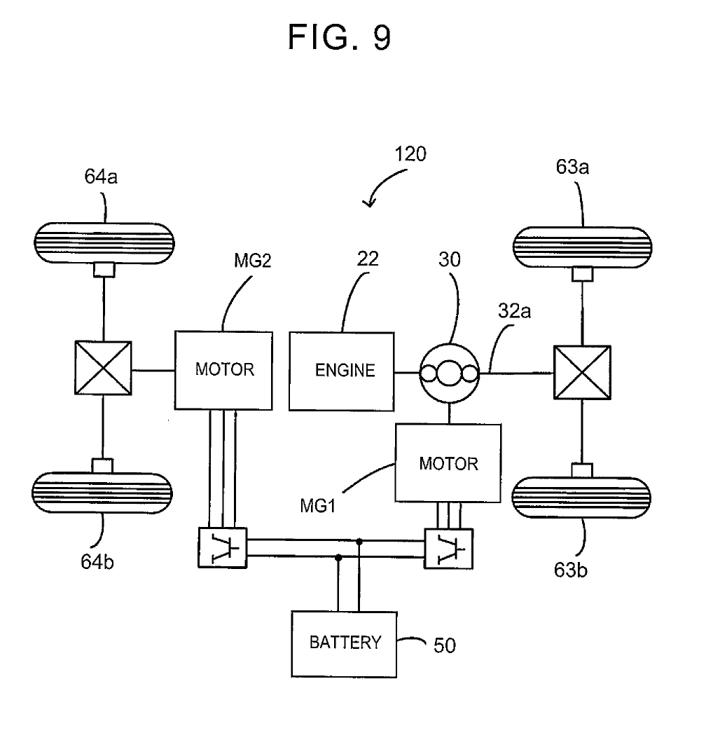

In the hybrid vehicle 20 according to the embodiment, the driving force of the motor MG2 is shifted in speed by the speed reduction gear 35 and is output to the ring gear shaft 32a. Instead, as illustrated in a hybrid vehicle 120 according to an alternative embodiment shown in FIG. 9, the driving force of the motor MG2 may be output to axles (axles respectively connected to wheels 64a, 64b in FIG. 9), different from the axles to which the ring gear shaft 32a is connected (axles to which the drive wheels 63a, 63b are connected).

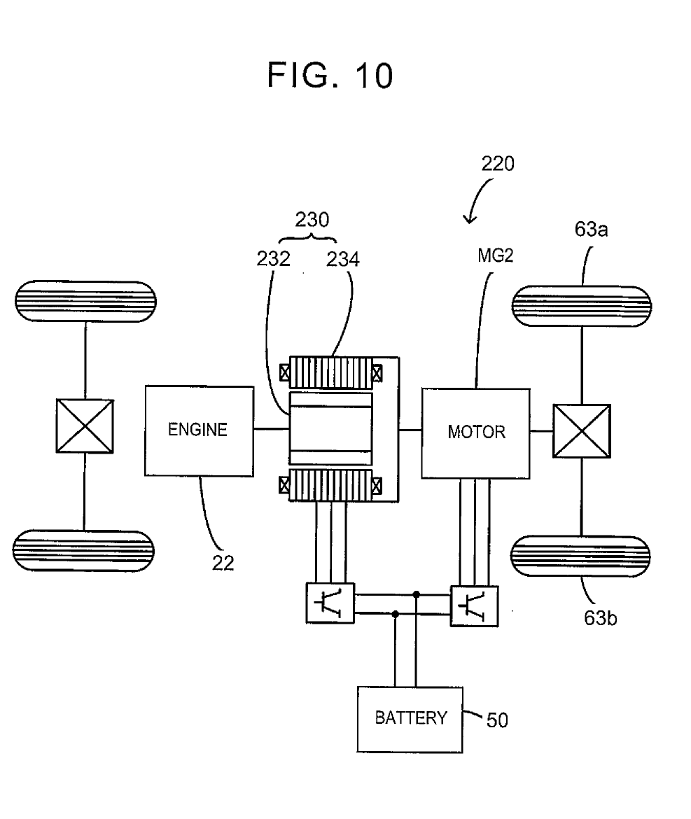

In the hybrid vehicle 20 according to the embodiment, the driving force of the engine 22 is output to the ring gear shaft 32a, which serves as the drive shaft connected to the drive wheels 63a, 63b, via the power distribution/integration mechanism 30. The invention is not limited to the above-described embodiment. The invention may be implemented as a hybrid vehicle 220 according to an alternative embodiment illustrated in FIG. 10. The hybrid vehicle 220 includes a twin rotor electric motor 230 that includes an inner rotor 232 and an outer rotor 234. The inner rotor 232 is connected to the crankshaft 26 of the engine 22. The outer rotor 234 is connected to the drive shaft that outputs driving force to the drive wheels 63a, 63b. The twin rotor electric motor 230 transmits part of the driving force of the engine 22 to the drive shaft and converts the remaining driving force to electric power.

In the embodiment, the engine 22 may be regarded as an “engine”, the motor MG1 may be regarded as a “first motor”, the power distribution/integration mechanism 30 may be regarded as a “planetary gear unit”, the motor MG2 may be regarded as a “second motor” and the battery 50 may be regarded as a “battery”. In addition, in the embodiment, the HVECU 70 that executes the acceleration drive control routine illustrated in FIG. 2, the engine ECU 24 that controls the engine 22 by receiving the target rotation speed Ne* and target torque Te* of the engine 22 from the HVECU 70 and the motor ECU 40 that controls the motors MG1, MG2 by receiving the torque commands Tm1*, Tm2* of the motors MG1, MG2 from the HVECU 70 may be regarded as a “control device”.

The mode for carrying out the invention is described with reference to the embodiment; however, the invention is not limited to the embodiment and may be implemented in various forms.

What is claimed is:

1. A hybrid vehicle comprising:
an engine;
a first motor;
a planetary gear unit including a ring gear connected to a drive shaft coupled to a wheel, a carrier connected to an output shaft of the engine, and a sun gear connected to a rotary shaft of the first motor;
a second motor of which a rotary shaft is connected to the drive shaft;
a battery configured to exchange electric power with the first motor and the second motor; and
a control device configured to control the engine, the first motor and the second motor so that the hybrid vehicle travels at a travel required power obtained by adding a charge required amount of the battery to a power required for the hybrid vehicle to travel while the engine is operated at a set target operation point,
wherein the control device is configured to, when acceleration is required, set a first operation point indicated by a first operation rotation speed and a first operation torque on a basis of an engine output power, obtained by subtracting an output limit of the battery from the travel required power, and a high torque constraint that outputting a high torque from the engine is given a higher priority than efficiently operating the engine; set a second operation point indicated by a second operation rotation speed and a second operation torque on a basis of the engine output power and a predetermined constraint that the engine is allowed to be efficiently operated; and set the target operation point so that a target rotation speed of the engine is varied at a predetermined temporal variation from the first operation rotation speed toward the second operation rotation speed and the engine output power is output from the engine, and
wherein the control device is configured to, when the rotation speed of the engine has reached the second operation rotation speed after the target rotation speed of the engine has been varied at the predetermined temporal variation from the first operation rotation speed toward the second operation rotation speed, set a third operation point indicated by a third operation rotation speed and a third operation torque on a basis of the travel required power and the predetermined constraint; and vary the target rotation speed at the predetermined temporal variation from the second operation rotation speed toward the third operation rotation speed and set the target operation point so that the engine is operated at the target operation point so as to operate the engine in accordance with the predetermined constraint.

2. The hybrid vehicle according to claim 1, wherein
the predetermined temporal variation is set so as to increase as an amount of electric power stored in the battery increases.

3. The hybrid vehicle according to claim 1, wherein
the predetermined temporal variation is set so as to increase as a road surface gradient increases.

4. The hybrid vehicle according to claim 1, wherein
in accordance with the predetermined constraint, the engine is operated along an operation line, the operation line being obtained by continuously arranging most efficient operation points of the engine while varying a power output from the engine, and
each of the most sufficient operation points is set among operation points at which the engine outputs a same power.

5. The hybrid vehicle according to claim 1, wherein
in accordance with the high torque constraint, the engine is operated along an operation line, the operation line being obtained by continuously arranging highest torque operation points of the engine while varying a power output from the engine, and
each of the highest torque operation points is set among operation points at which the engine outputs a same power.
